(19) United States
(12) Patent Application Publication
(10) Pub. No.: US 2026/0323753 A1
(43) Pub. Date: Oct. 15, 2026

(54) METHOD AND APPARATUS FOR PROVIDING NETWORK RESPONSE INFORMATION IN WIRELESS COMMUNICATION SYSTEM

(71) Applicant: SAMSUNG ELECTRONICS CO., LTD., Suwon-si, Gyeonggi-do (KR)

(72) Inventors: Sangbum KIM, Suwon-si (KR); Hyejeong KIM, Suwon-si (KR)

(21) Appl. No.: 18/997,772

(22) PCT Filed: Jul. 21, 2023
(86) PCT No.: PCT/KR2023/010534

§ 371 Date: Jan. 22, 2025

(30) Foreign Application Priority Data
Jul. 22, 2022 (KR) 10-2022-0090950

(51) Int. Cl. H04W 76/20; H04W 8/24; H04W 76/15

(52) U.S. Cl. CPC H04W 76/20; H04W 8/24; H04W 76/15

(57) ABSTRACT

The disclosure relates to a 5G or 6G communication system for supporting a higher data transmission rate. A method for operation of UE in a wireless communication system comprises the steps of: transmitting, to a base station, a first UE capability report regarding the UE; receiving, from the base station, an RRC message including configuration information for reporting a preference configuration of the UE; transmitting, to the base station on the basis of the configuration information, a reconfiguration request including the preference configuration; and if the reconfiguration request is identified as having been rejected, transmitting a second UE capability report to the base station.

### TECHNICAL FIELD

The disclosure relates to the operation of a terminal and a base station in a wireless communication system and, particularly to, a method and an apparatus for providing network response information.

### BACKGROUND ART

5G mobile communication technologies define broad frequency bands to enable high transmission rates and new services, and can be implemented not only in “Sub 6 GHz” bands such as 3.5 GHz, but also in ultrahigh frequency (“Above 6 GHz”) bands referred to as mmWave such as 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Embodiments set forth herein are to provide a device and a method capable of effectively providing services in a wireless communication system.

### Solution to Problem

In accordance with an aspect of the disclosure, a method for operating a terminal in a wireless communication system may include transmitting, to a base station, a first terminal capability report regarding the terminal, receiving, from the base station, a radio resource control (RRC) message including configuration information for reporting a preference configuration of the terminal, transmitting a reconfiguration request including the preference configuration to the base station, based on the configuration information, and in case that the reconfiguration request is identified as rejected, transmitting a second terminal capability report to the base station.

### Advantageous Effects of Invention

The disclosure provides a device and a method capable of effectively providing services in a wireless communication system.

### BRIEF DESCRIPTION OF DRAWINGS

FIG. 1A illustrates a structure of a wireless communication system according to an embodiment of the disclosure.

FIG. 1B is a flow diagram illustrating a process of reporting predetermined information reporting UE preferences to a base station in a wireless communication system according to an embodiment of the disclosure;

FIG. 1C is a flow diagram illustrating a process of recognizing network rejection by means of a predetermined timer in response to a reconfiguration request of a UE according to an embodiment of the disclosure;

FIG. ID is a flow diagram illustrating a process of recognizing network rejection by means of a predetermined indicator in response to a reconfiguration request of a UE according to an embodiment of the disclosure;

FIG. 1E is a flowchart illustrating a UE operation according to an embodiment of the disclosure;

FIG. 1F is a flowchart illustrating a base station operation according to an embodiment of the disclosure;

FIG. 1G is a block diagram showing the configuration of a UE according to an embodiment of the disclosure; and

FIG. 1H is a block diagram showing the configuration of a base station according to an embodiment of the disclosure.

### MODE FOR THE INVENTION

In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification. Hereinafter, embodiments the disclosure will be described with reference to the accompanying drawings. The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in the embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, the terms “physical channel” and “signal” may be interchangeably used with the term “data” or “control signal”. For example, the term “physical downlink shared channel (PDSCH)” refers to a physical channel over which data is transmitted, but the PDSCH may also be used to refer to the “data”. That is, in the disclosure, the expression “transmit ting a physical channel” may be construed as having the same meaning as the expression “transmitting data or a signal over a physical channel”.

In the following description of the disclosure, upper signaling refers to a signal transfer scheme from a base station to a terminal via a downlink data channel of a physical layer, or from a terminal to a base station via an uplink data channel of a physical layer. The upper signaling may also be understood as radio resource control (RRC) signaling or a media access control (MAC) control element (CE).

In the following description, some of terms and names defined in the 3GPP standards (standards for 5G, NR, LTE, or similar systems) may be used for the sake of descriptive convenience. However, the disclosure is not limited by these terms and names, and may be applied in the same way to systems that conform other standards. In the disclosure, the term “gNB” may be interchangeably used with the term “eNB” for the sake of descriptive convenience. That is, a base station described as “eNB” may refer to “gNB”. Furthermore, the term “terminal” may refer to not only a mobile phone, an MTC device, an NB-IoT device, and a sensor, but also other wireless communication devices.

In the following description, a base station is an entity that allocates resources to terminals, and may be at least one of a gNode B (gNB), an eNode B (eNB), a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Obviously, the examples given above are not limiting.

In particular, the disclosure may be applied to 3GPP NR (5th generation mobile communication standard). In addition, the disclosure may be applied to intelligent services (e.g., smart homes, smart buildings, smart cities, smart cars or connected cars, healthcare, digital education, retail business, security and safety-related services, etc.) on the basis of 5G communication technology and IoT-related technology. In the disclosure, the term “eNB” may be interchangeably used with the term “gNB” for the sake of descriptive convenience. That is, a base station described as “eNB” may refer to “gNB”. In addition, the term “terminal” may refer to not only mobile phones, NB-IoT devices, and sensors, but also any other wireless communication devices.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to some embodiments, eMBB may aim at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also require a packet error rate of 10-5 or less. Therefore, for the services supporting URLLC, a 5G system must provide a transmit time interval (TTI) shorter than those of other services, and may also require a design for assigning a large number of resources in a frequency band in order to secure reliability of a communication link.

The above-described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, mMTC, URLLC, and eMBB as described above are merely an example of different types of services, and service types to which the disclosure is applied are not limited to those mentioned above.

Furthermore, in the following description of embodiments of the disclosure, an LTE, LTE-A, LTE-Pro, or NR system will be described by way of example, but the embodiments of the disclosure may be applied to other communication systems having similar backgrounds or channel types. In addition, based on determinations by those skilled in the art, the embodiments of the disclosure may be applied to other communication systems through some modifications without significantly departing from the scope of the disclosure.

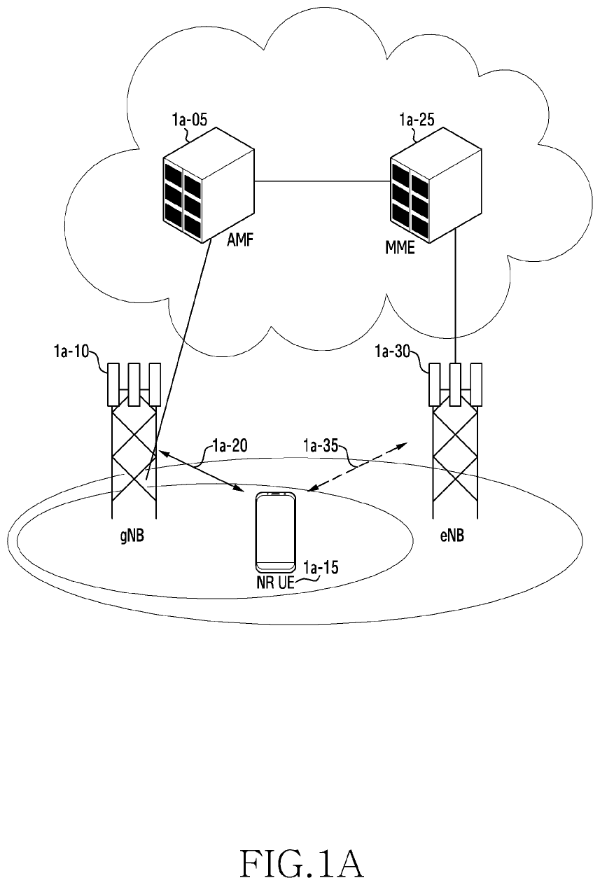

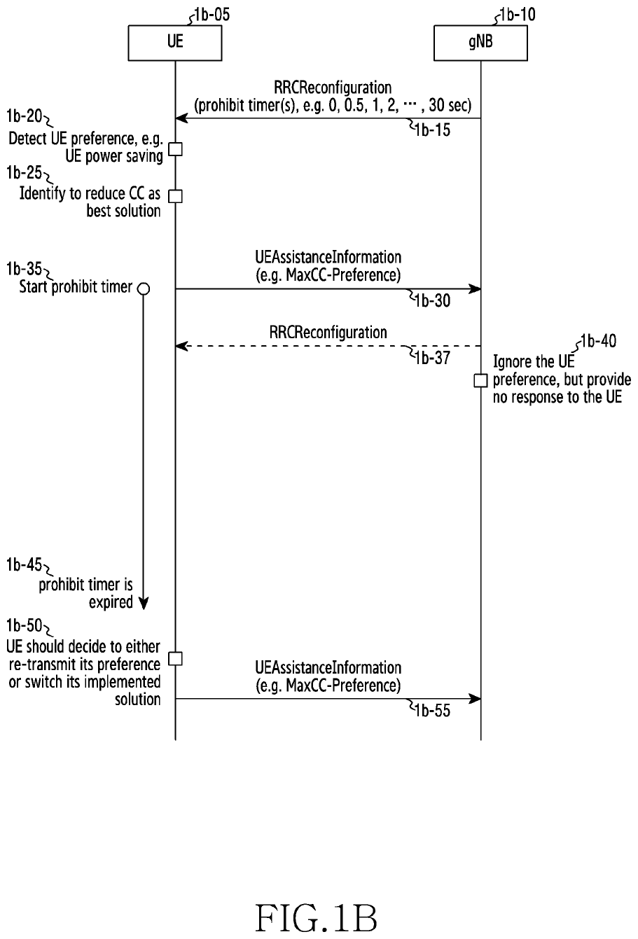

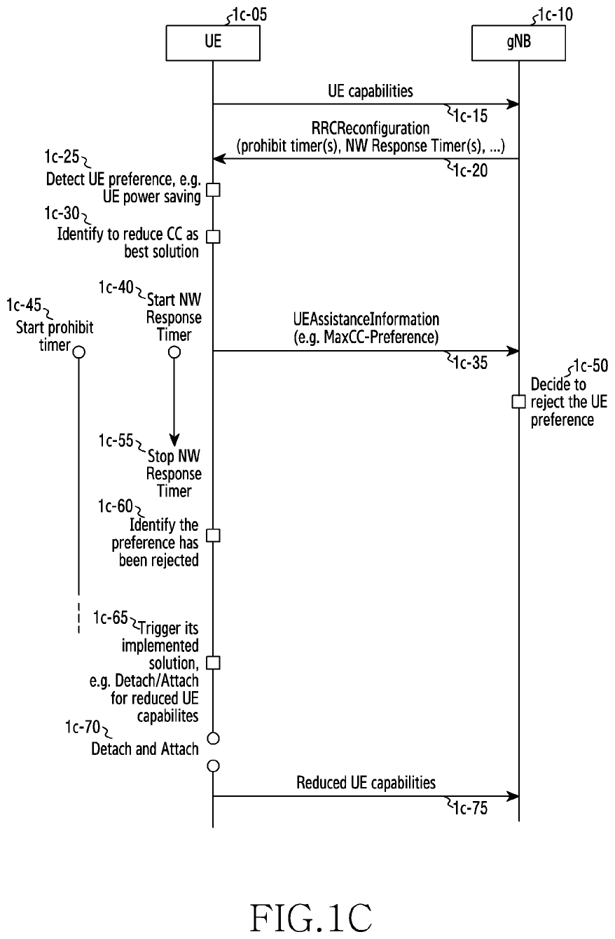

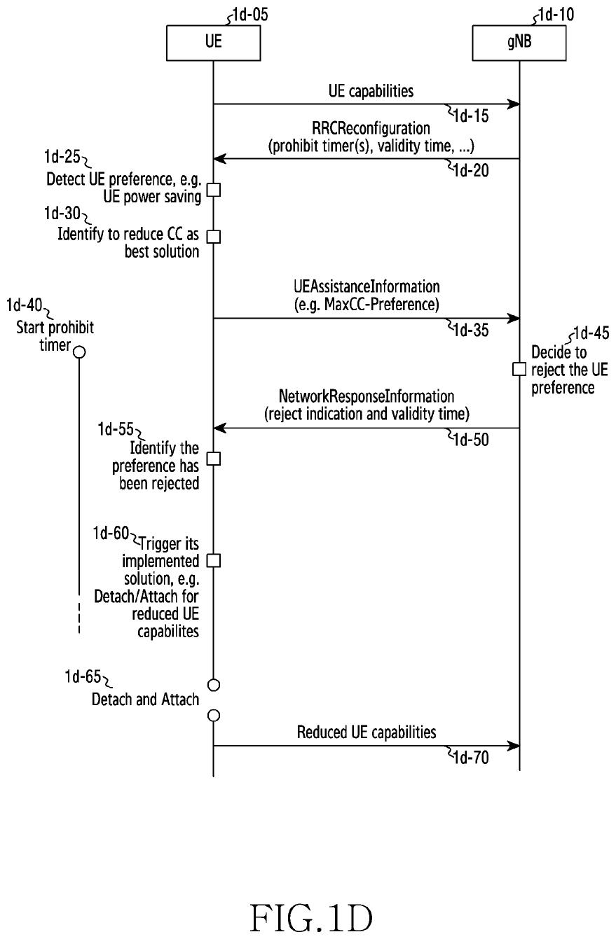

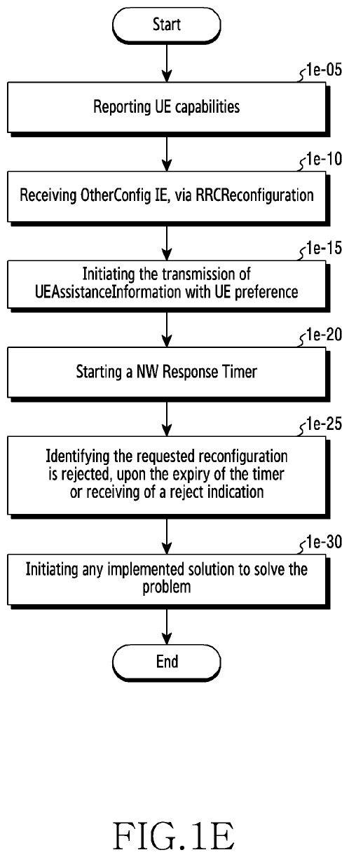

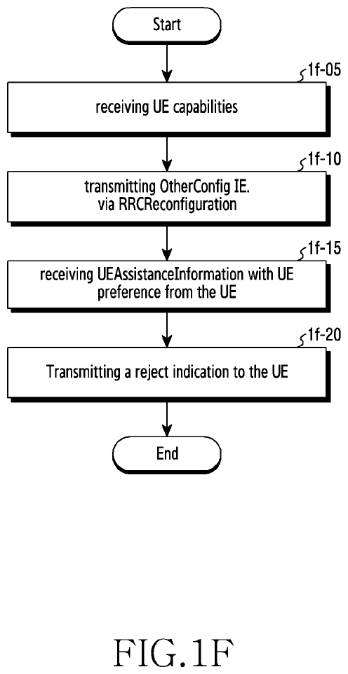

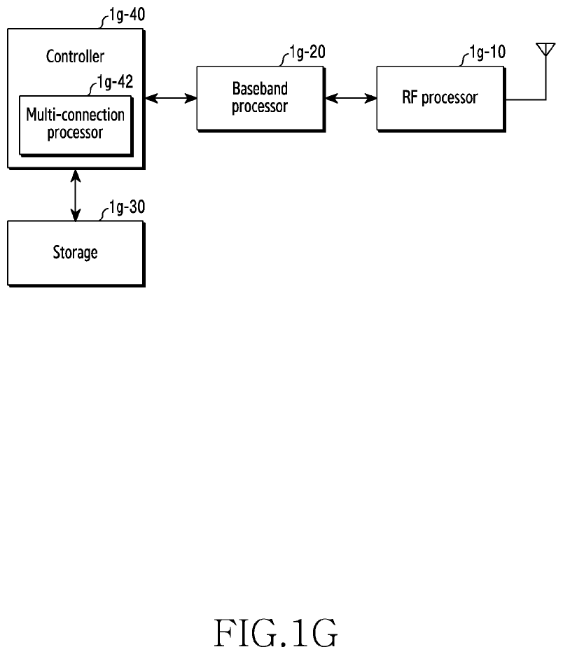

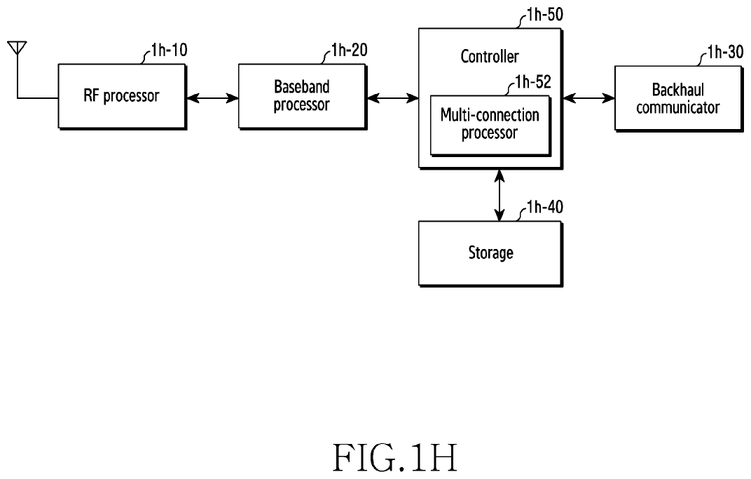

FIG. 1A illustrates a structure of a wireless communication system according to an embodiment of the disclosure.

Referring to FIG. 1A, as illustrated therein, a radio access network of a wireless communication system (new radio, NR) may include a base station (new radio node B, hereinafter gNB) 1a-10 and a new radio core network, and the new radio core network may include an access management function (AMF) 1a-05. Of course, a structure of the radio access network is not limited to the above example. A user terminal (new radio user equipment, hereinafter NR UE or NR terminal) 1a-15 may access an external network via the gNB 1a-10 and the AMF 1a-05.

In FIG. 1A, the gNB may correspond to an evolved node B (eNB) of a conventional LTE system. The gNB may be connected to the NR UE through a radio channel and provide outstanding services as compared to a conventional node B (1a-20). In the wireless communication system, since all user traffic is serviced through a shared channel, a device that collects state information, such as buffer statuses, available transmit power states, and channel states of UEs, and performs scheduling accordingly s required, and the gNB 1a-10 may serve as the device. In general, one gNB may control multiple cells. In order to implement ultrahigh-speed data transfer beyond the current LTE, the wireless communication system may have a wider bandwidth than the existing maximum bandwidth, may employ an orthogonal frequency division multiplexing (hereinafter referred to as OFDM) as a radio access technology, and may additionally integrate a beamforming technology therewith.

Furthermore, according to an embodiment of the disclosure, the wireless communication system may employ an adaptive modulation & coding (hereinafter referred to as AMC) scheme for determining a modulation scheme and a channel coding rate according to a channel state of a UE. The AMF 1a-05 may perform functions such as mobility support, bearer configuration, and QoS configuration. The AMF 1a-05 is a device responsible for various control functions as well as a mobility management function for a UE, and may be connected to multiple base stations. In addition, the wireless communication system may interwork with the existing LTE system, and the AMF may be connected to a mobility management entity (MME) 1a-25 via a network interface. The MME 1a-25 may be connected to an eNB 1a-30 that is an existing base station. A UE supporting LTE-NR dual connectivity (EN-DC) may transmit/receive data while maintaining connections to both the gNB and the eNB (1a-35).

FIG. 1B is a flow diagram illustrating a process of reporting predetermined information reporting UE preferences to a base station in a wireless communication system according to an embodiment of the disclosure.

Referring to FIG. 1B, in the wireless communication system according to an embodiment of the disclosure, a UE 1b-05 may report a configuration that the UE 1b-05 prefers compared to a current configuration for a predetermined purpose to a base station 1b-10. To this end, the base station 1b-10 may transmit configuration information for reporting the preferred configuration to the UE 1b-05 via the RRCReconfiguration message (indicated by reference numeral 1b-15). To prevent frequent reporting of preferred configuration, the configuration information for reporting the preferred configuration may include a predetermined prohibit timer. For example, the prohibit timer may be configured as 0 seconds, 0.5 seconds, 1 second, 2 seconds, . . . , and 30 seconds. The UE 1b-05 may report a separate preference configuration to the base station 1b-10 according to various purposes, and a dedicated prohibit timer may exist according to each purpose. A timer according to each purpose may be started when the preferred configuration corresponding to the purpose is transmitted to the base station 1b-10. Until the prohibit timer corresponding to each purpose expires, the UE 1b-05 may not transmit the preference configuration corresponding to the purpose to the base station 1b-10. For example, the purposes may be as follows.
Preferred delay budget
Preference for reducing power consumption (UE power preference)
Preference for heat reduction (overheating assistance)
IDC problem reporting and preferred solution (IDC assistance)
Solution to support multiple SIMs (MUSIM assistance), etc.

The UE 1b-05 may detect (or confirm, identify) that the UE power consumption should be reduced (indicated by reference numeral 1b-20), and to this end, the UE 1b-05 may recognize (or confirm, determine) that the maximum number of CCs should be reduced (indicated by reference numeral 1b-25). The UE 1b-05 may store the maximum number of preferred CCs in a predetermined information element (e.g., the MaxCC-Preference IE). The UE 1b-05 may transmit the UEAssistanceInformation message including the IE to the base station 1b-10 (indicated by reference numeral 1b-30). At this time, the UE 1b-05 may start one prohibit timer (e.g., maxCC-PreferenceProhibitTimer) corresponding to the maximum number of preferred CCs (indicated by reference numeral 1b-35).

The base station 1b-10 may trigger a reconfiguration in response to the preference configuration received from the UE 1b-05 (indicated by reference numeral 1b-37). For example, the base station 1b-10 that has received the preference configuration may reduce the maximum number of SCells and reconfigure the same for the UE 1b-05. On the other hand, whether or not the base station 1b-10 that has received the preference configuration performs a reconfiguration by reflecting the received preference configuration is determined by the implementation of the base station. Accordingly, the base station 1b-10 may ignore the preference configuration due to a predetermined reason (indicated by reference numeral 1b-40). However, it may be difficult for the UE 1b-05 to know whether the base station 1b-10 has rejected a request for reconfiguration. When the prohibit timer expires (indicated by reference numeral 1b-45), the UE 1b-05 may also retransmit the preference configuration to the base station 1b-10 (indicated by reference numeral 1b-55). The UE 1b-05 may have an implemented solution to address the purpose, in addition to the reconfiguration request via the UEAssistanceInformation message. Therefore, the UE 1b-05 may trigger an implemented solution in addition to the retransmission of the preferred configuration (indicated by reference numeral 1b-50).

In the operations in FIG. 1B, since the UE 1b-05 may not know whether the base station 1b-10 has rejected the reconfiguration request of the UE 1b-05, the UE 1b-05 may experience delays in resolving corresponding issues promptly. For example, in case that the UE 1b-05 is able to recognize that the base station 1b-10 will not reflect the reconfiguration request of the UE 1b-05, the UE 1b-05 may trigger an implemented solution immediately.

This embodiment proposes a method of notifying the UE that the base station will not perform a reconfiguration in response to a reconfiguration request reported by the UE.

FIG. 1C is a flow diagram illustrating a process of recognizing network rejection by means of a predetermined timer in response to a reconfiguration request of a UE according to an embodiment of the disclosure.

Referring to FIG. 1C, a UE 1c-05 may report UE capability information (e.g., UE capabilities) to a base station 1c-10 (indicated by reference numeral 1c-15). The UE capability information may include an indicator indicating whether or not the UE supports an operation of recognizing network rejection proposed in this embodiment. The base station 1c-10 may configure the UE 1c-05 to report a preferred configuration of the UE 1c-05 according to a predetermined purpose (indicated by reference numeral 1c-20). The following fields corresponding to a predetermined purpose may be stored in the OtherConfig IE of the RRCReconfiguration message. Each of the following fields may contain the configuration information required for the UE 1c-05 to perform the reporting according to the purpose, and the description thereof may be referred to TS38.331 (V17.1.0).
delayBudgetReportingConfig
overheatingAssistanceConfig
idc-AssistanceConfig
drx-PreferenceConfig
maxBW-PreferenceConfig
maxCC-PreferenceConfig
maxMIMO-LayerPreferenceConfig
minSchedulingOffsetPreferenceConfig
releasePreferenceConfig
referenceTimePreferenceReporting
ul-GapFR2-PreferenceConfig
musim-GapAssistanceConfig
musim-LeaveAssistanceConfig
maxBW-PreferenceConfigFR2-2
maxMIMO-LayerPreferenceConfigFR2-2
minSchedulingOffsetPreferenceConfigExt
rlm-RelaxationReportingConfig
bfd-RelaxationReportingConfig
scg-DeactivationPreferenceConfig

For example, overheatingAssistanceConfig may be configured to report preferred configuration to solve overheating problems, and drx-PreferenceConfig, maxBW-PreferenceConfig, maxCC-PreferenceConfig, maxMIMO-LayerPreferenceConfig, releasePreferenceConfig, maxBW-PreferenceConfigFR2-2, maxMIMO-LayerPreferenceConfigFR2-2, and scg-DeactivationPreferenceConfig may be configured to report preferred configuration to save power consumption of the UE. A prohibit timer corresponding to the configuration information for reporting each preference configuration may be configured.

In this embodiment, a new timer corresponding to each purpose may be proposed. In this embodiment, the new timer may be called a NW response timer. The new timer (e.g., NW response timer) may start running when preference configurations corresponding to a purpose are reported to the base station 1c-10. When the preferred configuration reported by the UE 1c-05 is not reconfigured by the base station 1c-10 until the new timer expires, the UE 1c-05 may consider that the base station 1c-10 has rejected the reconfiguration request. A configuration value of each new timer may be stored in the OtherConfig IE of the RRCReconfiguration message along with the corresponding field. The new timer may be stopped when a reporting configuration of the corresponding preferred configuration is released or when a specific operation (for example, a re-establishment operation or a resume operation) is performed.

The UE 1c-05 may detect that the UE power consumption should be reduced (indicated by reference numeral 1c-25). The UE 1c-05 may also recognize that the maximum number of CCs should be reduced (indicated by reference numeral 1c-30). The UE 1c-05 may store the maximum number of preferred CCs in a predetermined IE (e.g., the MaxCC-Preference IE) and transmit a UEAssistanceInformation message including the IE to the base station 1c-10 (indicated by reference numeral 1c-35). At this time, the UE may start one new timer corresponding to the information on the maximum number of preferred CCs (indicated by reference numeral 1c-40). Here, the UE may start one prohibit timer (e.g., maxCC-PreferenceProhibitTimer) corresponding to the information on the maximum number of preferred CCs (indicated by reference numeral 1c-45).

Whether or not the base station 1c-10 that has received reporting of the preference configuration performs a reconfiguration by reflecting the preference configuration is determined by the implementation of the base station 1c-10, and the base station 1c-10 may reject a reconfiguration request due to predetermined reasons (indicated by reference numeral 1c-50). When the new timer expires (indicated by reference numeral 1c-55), the UE 1c-05 may consider that the base station 1c-10 has rejected the reconfiguration request of the UE 1c-05 (indicated by reference numeral 1c-60). The UE 1c-05 may have an implemented solution to address the purpose, as well as the reconfiguration request via the UEAssistanceInformation message. Therefore, the UE 1c-05 may trigger an implemented solution in addition to retransmitting the preferred configuration to the base station 1c-10 (indicated by reference numeral 1c-65). For example, an implemented solution may be understood to mean that the UE 1c-05 performs detach and attach operations (indicated by reference numeral 1c-70) and then re-adjusts and reports the capabilities of the UE 1c-05 to the base station 1c-10 (indicated by reference numeral 1c-75). The detach and attach operations of the UE 1c-05 may refer to the operations of the UE 1c-05 deregistering from and re-registering with the network, and the UE 1c-05 may need to be in a connected mode (e.g., RRC connected mode) to re-register with the network. In an embodiment, the UE 1c-05 may report to the base station 1c-10 with a capability that is lower than the capability of the UE 1c-05 that has been reported to the base station 1c-10 in operation 1c-15. Accordingly, the UE 1c-05 may trigger an implemented solution by identifying whether there is a configuration from a network within a predetermined time according to a configuration value of the new timer. When the new timer expires, the UE 1c-05 may also restart the prohibited timer currently running. The configuration value of the new timer corresponding to a single preferred configuration may not be configured to be greater than the configuration value of a prohibited timer corresponding to the same preferred configuration.

In an embodiment, the prohibit timer may also perform the role of a new timer proposed in this embodiment. In this embodiment, a new timer may be referred to as an NW response timer. This may be understood to mean that when the prohibit timer expires, the UE 1c-05 may retransmit the preferred configuration, or that the previously transmitted reconfiguration request has been rejected by the network. In this case, there is an advantage in terms of signaling overhead as there is no need to redefine a new timer. However, there may be a disadvantage in that when the configuration value of the prohibit timer is greater than that of the new timer, it may be necessary to wait for a time corresponding to the configuration value of the prohibit timer in order to determine whether the reconfiguration request is rejected.

In a dual connectivity (DC) scenario, a secondary node (SN) may also provide a new timer.

FIG. 1D is a flow diagram illustrating a process of recognizing network rejection by means of a predetermined indicator in response to a reconfiguration request of a UE according to an embodiment of the disclosure.

Referring to FIG. 1D, a UE 1d-05 may report UE capability information (e.g., UE capabilities) to a base station 1d-10 (indicated by reference numeral 1d-15). The UE capability information may include an indicator indicating whether or not the UE supports an operation of recognizing network rejection proposed in this embodiment. The base station 1d-10 may configure the UE 1d-05 to report a preferred configuration of the UE 1d-05 according to a predetermined purpose (indicated by reference numeral 1d-20). The following fields corresponding to a predetermined purpose may be stored in the OtherConfig IE of the RRCReconfiguration message. Each of the following fields may contain the configuration information required for the UE 1d-05 to perform reporting according to the purpose, and the description thereof may be referred to TS38.331 (V17.1.0).
delayBudgetReportingConfig
overheatingAssistanceConfig
idc-AssistanceConfig
drx-PreferenceConfig
maxBW-PreferenceConfig
maxCC-PreferenceConfig
maxMIMO-LayerPreferenceConfig
minSchedulingOffsetPreferenceConfig
releasePreferenceConfig
referenceTimePreferenceReporting
ul-GapFR2-PreferenceConfig
musim-GapAssistanceConfig
musim-LeaveAssistanceConfig
maxBW-PreferenceConfigFR2-2
maxMIMO-LayerPreferenceConfigFR2-2
minSchedulingOffsetPreferenceConfigExt
rlm-RelaxationReportingConfig
bfd-RelaxationReportingConfig
scg-DeactivationPreferenceConfig

For example, overheatingAssistanceConfig may be configured as report the preferred configuration to solve the overheating problem, and drx-PreferenceConfig, maxBW-PreferenceConfig, maxCC-PreferenceConfig, maxMIMO-LayerPreferenceConfig, releasePreferenceConfig, maxBW-PreferenceConfigFR2-2, maxMIMO-LayerPreferenceConfigFR2-2, and scg-DeactivationPreferenceConfig may be configured to report the preferred configuration to save UE power consumption. A prohibit timer corresponding to the configuration information for each preference configuration report may be configured.

In an embodiment, one explicit indication may be proposed to reject the reconfiguration request of the UE 1d-05 corresponding to each purpose. The base station 1d-10 may indicate rejection of the reconfiguration request reported by the UE by using one of indicators stored in at least one of the predetermined RRC messages (e.g., the RRCReconfiguration message), MAC CE, or L1 signaling. The UE 1d-05 that has received a reject indicator from a base station 1d-10 may consider that the reconfiguration request of the UE 1d-05 has been rejected for an effective time (e.g., validity time). The validity time may be predefined or configured by the base station 1d-10. If the validity time is configured by the base station 1d-10, the information on the validity time may be stored in the OtherConfig IE of the RRCReconfiguration message along with the corresponding field. The validity time may be considered invalid when the reporting configuration of the corresponding preference configuration is released or when a specific operation (e.g., a re-establishment operation or a resumption operation) is performed.

The UE 1d-05 may detect that the UE power consumption should be reduced (indicated by reference numeral 1d-25). The UE 1d-05 may also recognize that the maximum number of CCs should be reduced (indicated by reference numeral 1d-30). The UE 1d-05 may store the maximum number of preferred CCs in a predetermined IE (e.g., the MaxCC-Preference IE) and transmit a UEAssistanceInformation message including the IE to the base station 1d-10 (indicated by reference numeral 1d-35). At this time, the UE may start one prohibit timer (e.g., maxCC-PreferenceProhibitTimer) corresponding to the information on the maximum number of preferred CCs (indicated by reference numeral 1d-40).

Whether or not the base station 1d-10 that has received reporting of the preference configuration performs a reconfiguration by reflecting the preference configuration is determined by the implementation of the base station 1d-10, and the base station 1d-10 may reject a reconfiguration request due to predetermined reasons (indicated by reference numeral 1d-45). At this time, the base station 1d-10 may transmit one reject indicator indicating rejection of the reconfiguration request to the UE 1d-05 (indicated by reference numeral 1d-50). The UE 1d-05 that has received the reject indicator may consider that the base station 1d-10 has rejected the reconfiguration request of the UE 1d-05 (indicated by reference numeral 1d-55). The UE 1d-05 may have an implemented solution to address the purpose, as well as the reconfiguration request via the UEAssistanceInformation message. Therefore, the UE 1d-05 may trigger an implemented solution in addition to retransmitting the preferred configuration to the base station 1d-10 (indicated by reference numeral 1d-60). For example, an implemented solution may be understood to mean that the UE 1d-05 performs detach and attach operations (indicated by reference numeral 1d-65) and then re-adjusts and reports the capabilities of the UE 1d-05 to the base station 1d-10 (indicated by reference numeral 1d-70). The detach and attach operations of the UE 1d-05 may refer to the operations of the UE 1d-05 deregistering from and re-registering with the network, and the UE 1d-05 may need to be in a connected mode (e.g., RRC connected mode) to re-register with the network. In an embodiment, the UE 1d-05 may report to the base station 1d-10 with a capability that is lower than the capability of the UE 1d-05 that has been reported to the base station 1d-10 in operation 1d-15. Accordingly, the UE 1d-05 may trigger an implemented solution by identifying whether there is a reconfiguration from the network within a predetermined time according to reception of the rejection indicator. Upon receiving the reject indicator, the UE 1d-05 may also restart the prohibit timer currently running.

In an embodiment, the prohibit timer may also serve as the validity time proposed in this embodiment. That is, when the UE 1d-05 receives the reject indicator, the prohibit timer is restarted and it may be considered that the reconfiguration request of the UE 1d-05 is rejected until the prohibit timer expires.

Here, since there is no need to redefine the validity time, there is an advantage in terms of signaling overhead. However, since the validity time cannot be configured separately from the prohibit timer, there may be a disadvantage of less flexibility in determining the configuration value of the validity time.

In a dual connectivity (DC) scenario, the SN may also provide the validity time.

The new timer and reject indicator may be configured and operated simultaneously.

FIG. 1E is a flowchart of a UE operation according to an embodiment of the disclosure.

Referring to FIG. 1E, in operation 1e-05, a UE may report its own capability information to a base station. The capability information may include an indicator indicating whether or not the UE supports an operation of recognizing network rejection proposed in this embodiment.

In the 1e-10 operation, the UE may receive, from the base station, an RRCReconfiguration message containing configuration information for reporting the configuration preferred by the UE according to a predetermined purpose. The configuration information for reporting preference information may include configuration values for a new timer and/or validity time.

In operation 1e-15, the UE may transmit, to the base station, a UEAssistanceInformation message containing preferred configuration for a specific purpose (e.g., UE power saving, overheating mitigation, etc.). The UE may request a reconfiguration from the base station by transmitting the UEAssistanceInformation message containing the preferred configuration to the base station.

In operation le-20, the UE may start a new timer.

In operation 1e-25, the UE may consider that the reconfiguration request has been rejected when the new timer expires or when the UE receives a predetermined reject indicator from the base station.

In operation 1e-30, the UE may trigger a predetermined implemented solution to achieve the purpose.

FIG. 1F is a flowchart of a base station operation according to an embodiment of the disclosure.

In operation 1f-05, the base station may receive one of UE capability information of a UE. The UE capability information may include an indicator indicating whether or not the UE supports an operation of recognizing network rejection proposed in this embodiment.

In operation 1f-10, the base station may transmit, to the UE, an RRCReconfiguration message containing configuration information to report the preferred configuration of the UE according to a predetermined purpose (e.g., UE power saving, overheating mitigation, etc.).

In operation 1f-15, the base station may receive, from the UE, a UEAssistanceInformation message containing the preferred configuration for the UE for a specific purpose.

In operation 1f-20, the base station may transmit a predetermined reject indicator to the UE.

FIG. 1G is block diagram illustrating the configuration of a UE according to an embodiment of the disclosure.

Referring to FIG. 1G, the UE may include a radio-frequency (RF) processor 1g-10, a baseband processor 1g-20, a storage 1g-30, and a controller 1g-40.

The RF processor 1g-10 may perform a function for transmitting and receiving a signal via a wireless channel, such as band conversion and amplification of the signal. That is, the RF processor 1g-10 may up-convert a baseband signal provided from the baseband processor 1g-20 to an RF band signal and then transmit the same through an antenna, and may down-convert an RF band signal received through the antenna to a baseband signal. For example, the RF processor 1g-10 may include a transmission filter, a reception filter, an amplifier, a mixer, an oscillator, a digital-to-analog converter (DAC), an analog-to-digital converter (ADC), etc. Of course, the configuration (component) of the RF processor 11-10 described above is only an example, and the RF processor 1g-10 may include other components or omit some of the components described above. In FIG. 1G, although only one antenna is illustrated, the UE may include multiple antennas. In addition, the RF processor 1g-10 may include a plurality of RF chains. Furthermore, the RF processor 1g-10 may perform beamforming. For the beamforming, the RF processor 1g-10 may adjust the phase and magnitude of each of signals transmitted and received through multiple antennas or antenna elements. In addition, the RF processor 1g-10 may perform MIMO, and may receive multiple layers when performing MIMO operations.

The baseband processor 1g-20 may perform a function of conversion between a baseband signal and a bit stream according to the physical-layer standard of a system. For example, during data transmission, the baseband processor 1g-20 may generate complex symbols by encoding and modulating a transmission bit stream. In addition, upon receiving data, the baseband processor 1g-20 may restore the received bit stream through demodulation and decoding of the baseband signal provided from the RF processor 1g-10. For example, in the case of conforming to an orthogonal frequency-division multiplexing (OFDM) method, when transmitting data, the baseband processor 1g-20 may encode and modulate a transmission bit stream to generate complex symbols, may map the complex symbols to subcarriers, and then may configure OFDM symbols via an inverse fast Fourier transform (IFFT) operation and cyclic prefix (CP) insertion. In addition, when receiving data, the baseband processor 1g-20 may divide the baseband signal provided from the RF processor 1g-10 into units of OFDM symbols, may restore signals mapped to subcarriers via the fast Fourier transform (FFT) operation, and then may restore a received bit stream via demodulation and decoding.

The baseband processor 1g-20 and the RF processor 1g-10 may transmit and receive signals as described above. Accordingly, each of the baseband processor 1g-20 and the RF processor 1g-10 may be referred to as a transmitter, a receiver, a transceiver, or a communicator. Furthermore, at least one of the baseband processor 1g-20 and the RF processor 1g-10 may include a plurality of communication modules to support a plurality of different radio access technologies. In addition, at least one of the baseband processor 1g-20 and the RF processor 1g-10 may include different communication modules to process signals in different frequency bands. For example, the different radio access technologies may include a wireless LAN (e.g., IEEE 802.11), a cellular network (e.g., LTE), and the like. In addition, the different frequency bands may include a super-high-frequency (SHF) (e.g., 2.NRHz, NRhz) band and a millimeter-wave (e.g., 60 GHz) band. The UE may transmit and/or receive signals to and/or from the base station by using the baseband processor 1g-20 and the RF processor 1g-10, and the signals may include control information and data.

The storage 1g-30 may store data such as a basic program, an application, or configuration information for the operation of the UE. In particular, the storage 1g-30 may store information related to the second access node, which performs wireless communication using the second wireless access technology. The storage 1g-30 provides stored data in response to a request from the controller 1g-40. The storage 11-30 may be configured by a storage medium or a combination of storage media, such as a ROM, a RAM, a hard disk, a CD-ROM, and a DVD. In addition, the storage 10-30 may be configured by a plurality of memories.

The controller 1g-40 may control the overall operation of the UE. For example, the controller 1g-40 may transmit and receive signals through the baseband processor 1g-20 and the RF processor 1g-10. In addition, the controller 1g-40 records and reads data in the storage 1g-30. To this end, the controller 1g-40 may include at least one processor. For example, the controller 1g-40 may include a communication processor (CP) that performs control for communication and an application processor (AP) that controls a higher layer such as an application. In addition, at least one configuration within the UE may be implemented in one chip. The controller 1g-40 described above may further include a multi-connection processor 1g-42 to support multiple connections.

FIG. 1H is a block diagram illustrating the configuration of a base station according to an embodiment of the disclosure.

Referring to FIG. 1H, the base station may include an RF processor 1h-10, a baseband processor 1h-20, a backhaul communicator 1h-30, a storage 1h-40, and a controller 1h-50.

The RF processor 1h-10 may perform a function for transmitting and receiving a signal via a wireless channel, such as band conversion and amplification of the signal. That is, the RF processor 1h-10 may up-convert a baseband signal provided from the baseband processor 1h-20 to an RF band signal and then transmit the same through an antenna, and may down-convert an RF band signal received through the antenna to a baseband signal. For example, the RF processor 1h-10 may include a transmission filter, a reception filter, an amplifier, a mixer, an oscillator, a digital-to-analog converter (DAC), an analog-to-digital converter (ADC), etc. In FIG. 1H, although only one antenna is illustrated, a first connection node or base station may include multiple antennas. In addition, the RF processor 1h-10 may include a plurality of RF chains. Furthermore, the RF processor 1h-10 may perform beamforming. For the beamforming, the RF processor 1h-10 may adjust the phase and magnitude of each of signals transmitted and received through multiple antennas or antenna elements. The RF processor may perform down-MIMO operations by transmitting one or more layers.

The baseband processor 1h-20 may perform a function of conversion between a baseband signal and a bit stream according to the physical layer standard of a first radio access technology. For example, during data transmission, the baseband processor 1h-20 may generate complex symbols by encoding and modulating a transmission bit stream. In addition, upon receiving data, the baseband processor 1h-20 may restore the received bit stream through demodulation and decoding of the baseband signal provided from the RF processor 1h-10. For example, in the case of conforming to the OFDM method, when transmitting data, the baseband processor 1h-20 may encode and modulate a transmission bit stream to generate complex symbols, map the complex symbols to subcarriers, and then configure OFDM symbols via an IFFT operation and CP insertion. In addition, when receiving data, the baseband processor 1h-20 may divide the baseband signal provided from the RF processor 1h-10 into units of OFDM symbols, restore signals mapped to subcarriers via the FFT operation, and then restore a received bit stream via demodulation and decoding. The baseband processor 1h-20 and the RF processor 1h-10 may transmit and receive signals as described above. Accordingly, each of the baseband processor 1h-20 and the RF processor 1h-10 may be referred to as a transmitter, a receiver, a transceiver, or a wireless communicator. The base station may transmit and/or receive signals to and/or from the UE by using the baseband processor 1h-20 and the RF processor 1h-10, and the signals may include control information and data.

The backhaul communicator 1h-30 may provide an interface for performing communication with other nodes in a network. That is, the backhaul communicator 1h-30 may convert a bit stream transmitted from the base station to another node, for example, an auxiliary base station or a core network, into a physical signal, and convert the physical signal received from the other node into a bit stream. The backhaul communicator 1m-30 may be included in the communicator.

The storage 1h-40 may store data such as a basic program, an application, and configuration information for the operation of a main base station. In particular, the storage 1h-40 may store information on bearers allocated to the connected UE, measurement results reported from the connected UE, and the like. In addition, the storage 1h-40 may store information serving as a criterion for determining whether to provide or stop multiple connections to the UE. In addition, the storage 1h-40 provides stored data in response to a request from the controller 1h-50. The storage 1m-40 may be configured by a storage medium or a combination of storage media, such as a ROM, a RAM, a hard disk, a CD-ROM, and a DVD. In addition, the storage 1m-40 may be configured by a plurality of memories.

The controller 1h-50 may control the overall operation of the main base station. For example, the controller 1h-50 transmits and receives signals through the baseband processor 1h-20 and the RF processor 1h-10 or through the backhaul communicator 1h-30. In addition, the controller 1h-50 records and reads data in the storage 1h-40. To this end, the controller 1h-50 may include at least one processor. In addition, at least one configuration of the base station may be implemented in one chip. The controller 1h-50 described above may further include a multi-connection processor 1h-52 to support multiple connections.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof. That is, it will be apparent to those skilled in the art that other variants based on the technical idea of the disclosure may be implemented. Also, the above respective embodiments may be employed in combination, as necessary. For example, the methods proposed in the disclosure may be partially combined with each other to operate a network entity and a terminal. Moreover, although the above embodiments have been described based on the 5G or NR system, other variants based on the technical idea of the embodiments may also be implemented in other communication systems such as LTE, LTE-A, and LTE-A-Pro systems.

1. A method performed by a terminal in a wireless communication system, the method comprising:
receiving, from a base station, a radio resource control (RRC) message including configuration information for reporting a preference configuration of the terminal;
transmitting, to the base station, the preference configuration of the terminal based on the configuration information; and
identifying the preference configuration of the terminal as rejected based on information received from the base station.

2. The method of claim 1, wherein the preference configuration of the terminal is identified as rejected, based on a timer included in the information received from the base station, and
wherein the timer is a timer related to a transmission time of the preferred configuration of the terminal or a reception time of a network response to the preference configuration of the terminal.

3. The method of claim 1, wherein the preference configuration of the terminal is identified as rejected, based on an indicator included in the information received from the base station, and
wherein the indicator indicates rejection of the preference configuration of the terminal.

4. The method of claim 1, further comprising,
transmitting, to the base station, information related to the preference configuration of the terminal,
wherein the information related to the preference configuration of the terminal comprises the preference configuration of the terminal or capability information of the terminal, reduced based on the preference configuration of the terminal.

5. A method performed by a base station in a wireless communication system, the method comprising:
transmitting, to a terminal, a radio resource control (RRC) message including configuration information for reporting a preference configuration of the terminal; and
receiving, from the terminal, the preference configuration of the terminal based on the configuration information,
wherein the preference configuration of the terminal is identified as rejected, based on information transmitted to the terminal.

6. The method of claim 5, wherein the preference configuration of the terminal is identified as rejected, based on a timer included in the information transmitted to the terminal, and
wherein the timer is a timer related to a transmission time of the preference configuration of the terminal or a reception time of a network response to the preference configuration of the terminal.

7. The method of claim 5, wherein the preference configuration of the terminal is identified as rejected, based on an indicator included in information transmitted to the terminal, and
wherein the indicator indicates rejection of the preference configuration of the terminal.

8. The method of claim 5, further comprising,
receiving, from the terminal, information related to the preference configuration of the terminal,
wherein the information related to the preference configuration of the terminal comprises the preference configuration of the terminal or capability information of the terminal, reduced based on the preference configuration of the terminal.

9. A terminal in a wireless communication system, the terminal comprising:
a transceiver; and
at least one processor coupled with the transceiver and configured to:
receive, from a base station, a radio resource control (RRC) message including configuration information for reporting a preference configuration of the terminal,
transmit, to the base station, the preference configuration of the terminal based on the configuration information, and
identify the preference configuration of the terminal as rejected based on information received from the base station.

10. The terminal of claim 9, wherein the preference configuration of the terminal is identified as rejected, based on a timer included in the information received from the base station, and
wherein the timer is a timer related to a transmission time of the preference configuration of the terminal or a reception time of a network response to the preference configuration of the terminal.

11. The terminal of claim 9, wherein the preference configuration of the terminal is identified as rejected, based on an indicator included in the information received from the base station, and
wherein the indicator indicates rejection of the preference configuration of the terminal.

12. The terminal claim 9, wherein the information related to the preference configuration of the terminal comprises the preference configuration of the terminal or capability information of the terminal, reduced based on the preference configuration of the terminal.

13. A base station in a wireless communication system, the base station comprising:
a transceiver; and
at least one processor coupled with the transceiver and configured to:
transmit, to a terminal, a radio resource control (RRC) message including configuration information for reporting a preference configuration of the terminal, and
receive, from the terminal, the preference configuration of the terminal based on the configuration information,
wherein the preference configuration of the terminal is identified as rejected, based on information transmitted to the terminal.

14. The base station of claim 13, wherein the preference configuration of the terminal is identified as rejected, based on a timer included in the information transmitted to the terminal, and
wherein the timer is a timer related to a transmission time of the preference configuration of the terminal or a reception time of a network response to the preference configuration of the terminal.

15. The base station of claim 13, wherein the preference configuration of the terminal is identified as rejected, based on an indicator included in information transmitted to the terminal, and
wherein the indicator indicates rejection of the preference configuration of the terminal.
